(19) United States
(12) Patent Application Publication
(10) Pub. No.: US 2014/0244479 A1
(43) Pub. Date: Aug. 28, 2014

(54) Process for Utilizing Web Data In Making Lending Decisions

(71) Applicant: On Deck Capital, Inc., New York, NY (US)

(72) Inventors: Michael White, New York, NY (US); Greg Lamp, New York, NY (US); Matthew Gillen, New York, NY (US)

(73) Assignee: On Deck Capital, Inc., New York, NY (US)

(21) Appl. No.: 14/193,011

(22) Filed: Feb. 28, 2014

Related U.S. Application Data
(60) Provisional application No. 61/770,799, filed on Feb. 28, 2013.

(51) Int. Cl. G06Q 40/02

(52) U.S. Cl. CPC G06Q 40/025
USPC 705/38

(57) ABSTRACT

The disclosure relates to a process for utilizing web data, primarily obtained from social media websites in lending decisions business loan. Using the process, a lender can utilize publicly available data regarding a loan applicant, and evaluate that data in conjunction with other information to make lending decisions. The disclosure is directed toward loan transactions for small businesses.

### FIELD OF THE INVENTION

The disclosed embodiments relate generally to a process for aggregating and analyzing web data during the underwriting process of a business loan. In particular, the web data is obtained from social media websites.

### BACKGROUND

Traditionally, financial products, such as loans, have been marketed largely through financial institutions' literature and agents. The financial service provider relies on the agents for a large number of tasks, including acquiring demographic information, verifying the accuracy of the information, evaluating the information, and offering to sell products to the customer.

Technology has changed the landscape of the financial services industry such that agents play an increasingly shrinking role in marketing the financial products to potential borrowers. As the Internet has grown in popularity, potential borrowers shop for financial services over the Internet without the aid of an agent. A growing number of online companies also provide loan services; however, these online companies currently fall short of fully automating the loan process. In the case of financial institutions, potential borrowers can apply for loans or other financial services online; however, the loan approval process still requires the involvement of an agent. Third party providers of financial services can provide a list of available financial services based on criteria provided by the potential borrower, but the potential borrower must still contact the financial services agency directly or await a contact by an agent of the financial services agency.

A large percentage of these potential borrowers are the owners of small businesses. Small businesses encounter a number of unique challenges when trying to secure financing. The lack of a cost-effective infrastructure to efficiently analyze small businesses has forced financial institutions to rely on an inaccurate shortcut: The personal credit score of the owner. It is a fast and inexpensive way to make a judgment. However, it reflects the personal payment history of an individual, not the current financial state of the business. While this piece of data is easy to procure, it is a highly inaccurate indicator of creditworthiness. The problem in relying on the personal credit score becomes especially pronounced because many small business owners use personal credit to initially build their businesses, which creates a roadblock to accessing capital once they have become more established.

Thus, it is desirable for lenders to rely on more information than just the personal credit score of a small business owner. The internet is rife with available information regarding particular small businesses and owners. Social media has become a major presence in American society. For example, a number of web sites contain online reviews of businesses from customers. A non-exclusive list of these websites include: yelp, Google places, foursquare, and the Better Business Bureau. In addition to customer reviews, these websites also provide quantitative data. This data will be referred to as “web data.” Web data can be used to supplement existing data in making underwriting decisions.

### SUMMARY

The present invention addresses the needs of lenders by creating a method which uses publicly available web data to add value to the underwriting process. Utilizing the present invention allows a lender to rely on publicly available data to make quicker and more accurate lending assessment for small businesses.

In one embodiment, the web data is aggregated and the association of publicly available data to a loan applicant is verified. Once the verification takes place, an algorithm is used to convert web data into a numerical value, which can be added or subtracted to a pre-existing score.

In another embodiment, the web data is used as a trigger, for example, the existence of negative information, the volume of customer engagement such as the number of reviews or followers, or information that conflicts with the loan application, prompts an underwriter to take certain actions, such a reading the web data and preforming a more in-depth review.

### DETAILED DESCRIPTION

The present invention relates to a method for using publicly available web data to supplement conventional data during the underwriting process. Web data is an attractive source of information because it provides a number of key benefits. Web data is free, relevant, flexible, both backward and forward-looking and orthogonal. It provides useful information on how well a business is performing and satisfying its customers, and additionally has predictive value because web data drives future business. Additionally, it has been determined that web data is correlated to a business's performance and the risk in providing that business with a loan. Based on case studies, ratings from web data correlate with revenue, risk but not with credit scores received from conventional sources.

The present invention can best be understood by examples which illustrate the two main functions. Example 1 describes the process of adjusting the credit score of a loan applicant based on web data. Once a business applies for a loan, its information is entered into an underwriting program and a query is made to one or more social media websites, such as Google Places. Through the use of an entity matching algorithm, the record matches the data returned from the social media website to the merchant data entered into its system. If the data is a match the program proceeds. If multiple social media websites are accessed, the attributes from each data source may be treated separately, or they may aggregated together, for instance, creating a summary attribute of total number of reviews from across 2 or more different social media websites. The aggregation can be done using measures such as average, median, or maximum values for certain attributes and comparisons can be made over time. Data can be analyzed in either its raw format or normalized, for example by comparing attributes to similar businesses in a local geographic area.

Examples of attributes considered include data points such as the number of online reviews or ratings, the frequency of ratings, the average rating, or specific text within each review or comment. Algorithms to filter data points that may be considered outliers or not representative of the business's reputation may be applied by filtering on user information of the person submitting the review or comparing the business's profile across multiple websites and comparable businesses. These aggregated attributes are then evaluated to determine if they are indicative of higher or lower credit risk. This assessment of risk can be based on the results of a regression model, neural network or decision tree applied to quantified loan performance data and controlling for other attributes related to the business, such as industry, geography, credit ratings, and cash flow. In the absence of data, identification of attributes that differentiate credit risk, such as whether contact information is consistent across multiple websites or whether a business is engaged in activities that fall into a predefined restricted industry list can also be determined by human judgment.

Once this assessment has been made, several options are contemplated by the present invention. It may assign an applicant a higher or lower risk rating based on this information based on the output of a credit scoring model, such as a multivariate logistic regression, and use this rating to evaluate the suitability of different credit offers. It may use this information to send a loan application to a manual underwriting queue for additional review and due diligence (see Example 2). It may decline an application automatically if it fails to meet certain criteria. It may also use this data to determine whether a business is a suitable candidate for a direct marketing campaign. Once a decision has been made, this data will be stored in the system for future analysis to measure the accuracy and precision of this underwriting tool and make future models more accurate.

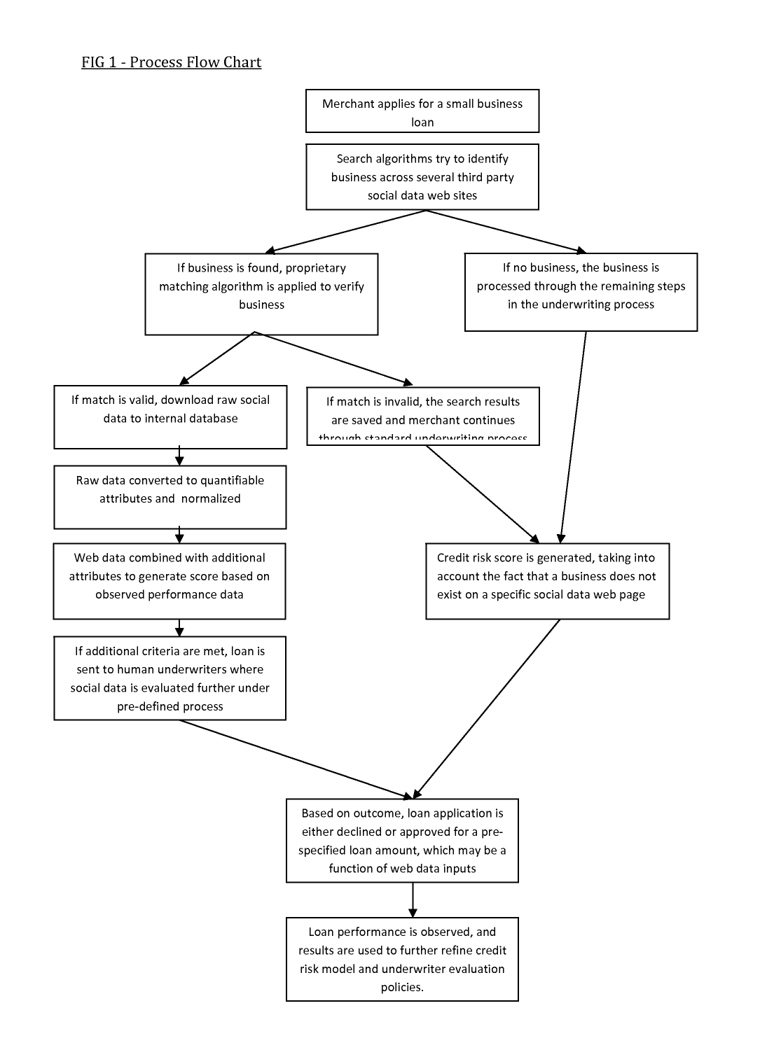

FIG. 1 describes a flow chart showing how the process described above is implemented.

Example 2 describes how software that processes a loan application can be used to guide an underwriter through the use of web data. For example, if an approved business has less than 4 stars on a specific website, an underwriter will be prompted by the software to visit the specific page (the link will be populated so it should be easy for the agent to navigate to the page). The agent will then read an optimum number of reviews, for example, the first 10 reviews (10 being the number of reviews shown on the first landing page) and respond to questions which will appear in an object visible only to the Underwriting team. The following are a representative list of possible questions that have been found to be relevant to underwriting decisions:

Robustness of Reviews

1. How many ratings are there in total? (Pick List: 0, 1-4, 5-10, 11-25, 26-50, 51-100, 101+)
2. Do at least 7 of the first 10 ratings have a text review? (Pick list: Yes/No)

Relevancy of Reviews/Trends

3. How old is the most recent review? (Pick List: Within the past week, month, 3 months, 6 months, year, greater than 1 year)
4. How many ratings have there been in the past 6 months? (Pick List: 0, 1, 2, 3-5, 5-10, 10+)
5. What is the average score for the 5 most recent ratings? (Agent will enter 5 values, and the software will calculate the score.)
6. Has anyone found the reviews to be helpful? (Pick List: Yes/No)

Unfair Business Practice

7. Do any reviews allege fraudulent, deceptive, or illegal business practices? (Pick List: Yes/No, examples include mentions of scams, law suits, criminal investigations, or Better Business Bureau complaints)

Business is Closed

8. Do any of the 10 most recent reviews refer to the business being closed or suspending operations? (Pick List: Yes/No)
9. Does a message stating “This place is permanently closed” appear beneath the business name? (Pick List: Yes/No)

Business Credit

10. Do any reviews reference failure to provide contracted services? (Pick List: Yes/No, examples include Customers being unable to contact the merchant for extended periods of time, Repeated No-Shows for appointment, Refusal to provide refund after failing to fulfill terms of contracts, and law suits)
11. Do any reviews reference failure to pay vendors or suppliers? (Pick List: Yes/No)

Overall Impression

12. Do you see anything else that makes you cautious about lending to this business, such as multiple reviews addressing unsanitary conditions, disorganization, unreliable service? (Pick List: Yes/No, Space to enter comments, for example, multiple reviews addressing inexperience/disorganization of the business.

Enough negative responses to the questions would be a trigger for the underwriter to call applicant and perform additional diligence. Additional diligence might include requesting more financial data. In one embodiment, further diligence would be required when at least one of the following were true: deposit volumes, credit card transaction volumes, or average bank balances are trending downward, and a business has an average rating of <3 stars, 3 or more of the 5 most recent ratings are 1 or 2 stars, or the answer to any of questions 7-12 are yes.

Example 3 describes an excerpt of one embodiment of a credit risk model that adds or subtracts points based on whether a business appears on a social media web site, and if so, what its rating is. The formula looks at the average user rating for a business from a social media website and converts it into a quantified variable based on its value. This quantified variable will then be added to an array of additional attributes related to a business's credit history and cash flow (referred to as Base Risk Model Value). The sum of these converted attributes is a credit risk model that can be used for underwriting a small business loan.

Base Risk Model Value+IF (VALUE(Web Data Rating)>=3.0, 15, IF (AND( NOT(ISBLANK(Web Data Rating)), VALUE(Web Data Rating)<3.0, Indicator that business on application matches business on social media=TRUE), −13.0))

As can be seen from the Examples, the present invention contemplates using both quantitative and qualitative web data in a variety of way to enhance the underwriting process and to minimize risk.

Although the present invention has been described with reference to preferred embodiments, workers skilled in the art will recognize that changes may be made in form and detail without departing from the spirit and scope of the invention.

We claim:

1. A process for utilizing web data about a loan applicant in making lending decisions, comprising:
receiving loan application information from a loan applicant;
obtaining web data from one or more websites;
verifying that the web data obtained relates to the particular loan applicant;
evaluating the web data to determine various criteria; and
making lending decisions based on that criteria.

2. The process of claim 1, wherein the web data is aggregated before determining the various criteria.

3. The process of claim 1, wherein the web data includes online customer reviews.

4. The process of claim 1, wherein after the web data is evaluated, it is filtered to remove outliers.
